(19) United States
(12) Patent Application Publication
(10) Pub. No.: US 2025/0115053 A1
(43) Pub. Date: Apr. 10, 2025

(54) LIQUID DISCHARGE HEAD AND LIQUID DISCHARGE APPARATUS

(71) Applicant: CANON KABUSHIKI KAISHA, Tokyo (JP)

(72) Inventor: KAZUYUKI YOSHIDA, Kanagawa (JP)

(21) Appl. No.: 18/905,711

(22) Filed: Oct. 3, 2024

(30) Foreign Application Priority Data
Oct. 5, 2023 (JP) 2023-173397

(51) Int. Cl. B41J 2/175; B41J 2/18; B41J 25/00

(52) U.S. Cl. CPC B41J 2/17596; B41J 2/18; B41J 25/001; B41P 2251/11

(57) ABSTRACT

A liquid discharge head includes a discharge element substrate configured to discharge a liquid, an upstream-side flow path connected to the discharge element substrate and configured to supply a liquid to the discharge element substrate, a downstream-side flow path connected to the discharge element substrate and configured to collect a liquid from the discharge element substrate, and a pump connected to each of the upstream-side flow path and the downstream-side flow path and configured to cause a liquid within the downstream-side flow path to flow out to the upstream-side flow path, wherein the pump includes a pump outflow hole for causing the liquid within the downstream-side flow path to flow out to the upstream-side flow path, and wherein, in a use state of the liquid discharge head, an opening of the pump outflow hole faces upward in a substantially vertical direction.

### BACKGROUND

### Field

The present disclosure relates to a liquid discharge head and a liquid discharge apparatus.

### Description of the Related Art

A liquid discharge head for discharging a liquid is mounted on a liquid discharge apparatus, and the liquid discharge head discharges a liquid to achieve a desired objective. For example, in an inkjet printing apparatus, an inkjet print head serving as a liquid discharge head is mounted on a carriage, and by discharging ink from a discharge element substrate included in the inkjet print head, the inkjet printing apparatus prints images, characters, and the like on a recording medium to be printed.

Discharge ports formed in the discharge element substrate are exposed to the external air, and thus liquid components in ink contained in the inkjet print head evaporate with time. The evaporation of liquid components in ink may cause thickening of ink or settling of a color material in ink.

To address such issues, Japanese Patent Application Laid-Open No. 2023-90627 discusses a liquid discharge head including a pump for circulating ink. The liquid discharge head including the pump enables a liquid in a downstream-side flow path for collecting a liquid from a discharge element substrate to flow out to an upstream-side flow path for supplying a liquid to the discharge element substrate. In other words, ink is continuously circulated in the liquid discharge head, thereby preventing thickening of ink and preventing a color material in the ink from settling.

Ink may contain air and the air may generate air bubbles in the ink.

The pump circulates a liquid using a change in pressure within the pump. Accordingly, if air bubbles are trapped in the pump as described above, the air bubbles are expanded and shrunk repeatedly, which causes a loss in the variation of pressure generated by the pump. In other words, there is a concern that the amount of liquid to be sent by the pump may decrease. Therefore, the pump may be desirably configured to prevent air bubbles from being trapped in the pump.

However, in the liquid discharge head discussed in Japanese Patent Application Laid-Open No. 2023-90627, an opening of a pump outflow hole of the pump for causing a liquid in the downstream-side flow path to flow out to the upstream-side flow path is directed in a substantially horizontal direction in a use state of the liquid discharge head, and thus the liquid discharge head discussed in Japanese Patent Application Laid-Open No. 2023-90627 is not configured to facilitate discharge of air bubbles. Specifically, since a buoyant force acts on air bubbles in ink in a vertical direction, it makes it difficult to cause the air bubbles moving due to the buoyant force to flow out from the inside of the pump if the opening of the pump outflow hole is directed in the substantially horizontal direction. As a result, air bubbles are more likely to be trapped in the pump.

### SUMMARY

In view of the above-described issues, the present disclosure is directed to providing a liquid discharge head including a pump that facilitates discharge of air bubbles trapped in the pump, and a liquid discharge apparatus including the liquid discharge head.

According to some embodiments, a liquid discharge head includes a discharge element substrate configured to discharge a liquid, an upstream-side flow path connected to the discharge element substrate and configured to supply a liquid to the discharge element substrate, a downstream-side flow path connected to the discharge element substrate and configured to collect a liquid from the discharge element substrate, and a pump connected to each of the upstream-side flow path and the downstream-side flow path and configured to cause a liquid within the downstream-side flow path to flow out to the upstream-side flow path, wherein the pump includes a pump outflow hole for causing the liquid within the downstream-side flow path to flow out to the upstream-side flow path, and wherein, in a use state of the liquid discharge head, an opening of the pump outflow hole faces upward in a substantially vertical direction.

Further features of the present disclosure will become apparent from the following description of exemplary embodiments with reference to the attached drawings.

### BRIEF DESCRIPTION OF THE DRAWINGS

FIG. 1 is an external perspective view of a liquid discharge head according to a first exemplary embodiment.

FIG. 2 is a schematic diagram illustrating a flow of liquid within a liquid discharge apparatus.

FIG. 3 is an external perspective view of a pump.

FIG. 4 is a sectional view of the pump.

FIG. 5 is an exploded perspective view of a connecting unit.

FIG. 6A is a schematic front view of a pressure regulation tank, FIG. 6B is a schematic side view of the pressure regulation tank, and FIG. 6C is a schematic top view of the pressure regulation tank.

FIG. 7A is a schematic sectional view of an upstream-side pressure regulation portion, FIG. 7B is a schematic sectional view of the upstream-side pressure regulation portion in a state where a communication port is open, and FIG. 7C is a schematic sectional view of the upstream-side pressure regulation portion in a state where the communication port is closed.

FIG. 8 is an external front view of the liquid discharge head.

FIG. 9 is a sectional view of the pump.

### DESCRIPTION OF THE EMBODIMENTS

Various exemplary embodiments, features, and aspects of the present disclosure will be described below with reference to the drawings. The following exemplary embodiments are not intended to limit features of the present disclosure, and not all combinations of features described in the exemplary embodiments are necessarily deemed to be essential. The same components are denoted by the same reference numerals.

### (Liquid Discharge Head)

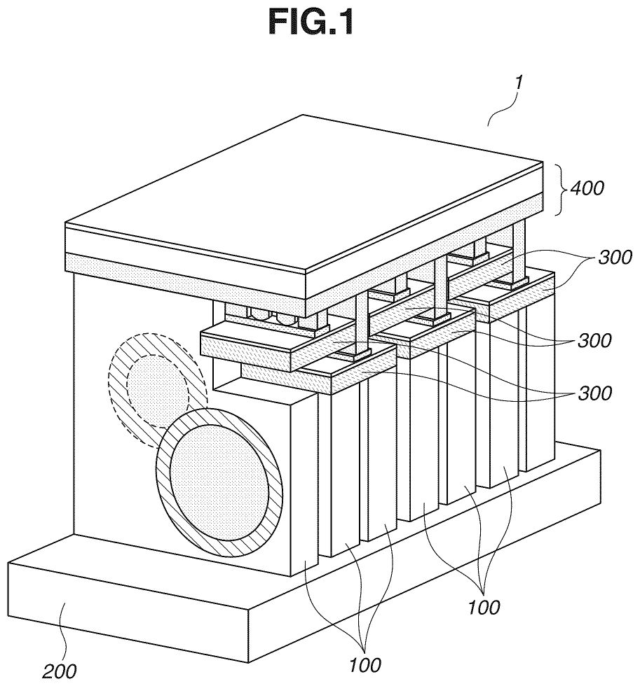

FIG. 1 is an external perspective view of a liquid discharge head 1 according to a first exemplary embodiment of the present disclosure. The liquid discharge head 1 is a member that is located in a liquid discharge apparatus in a state where the liquid discharge head 1 is mounted on a carriage (not illustrated) for mounting the liquid discharge head 1, and discharges a liquid to achieve a desired objective. The liquid discharge head 1 according to the first exemplary embodiment is an inkjet print head that discharges ink to print images, characters, and the like on a recording medium to be printed. The present exemplary embodiment is not limited to an inkjet print head that discharges ink, but instead may be applied to any liquid discharge head.

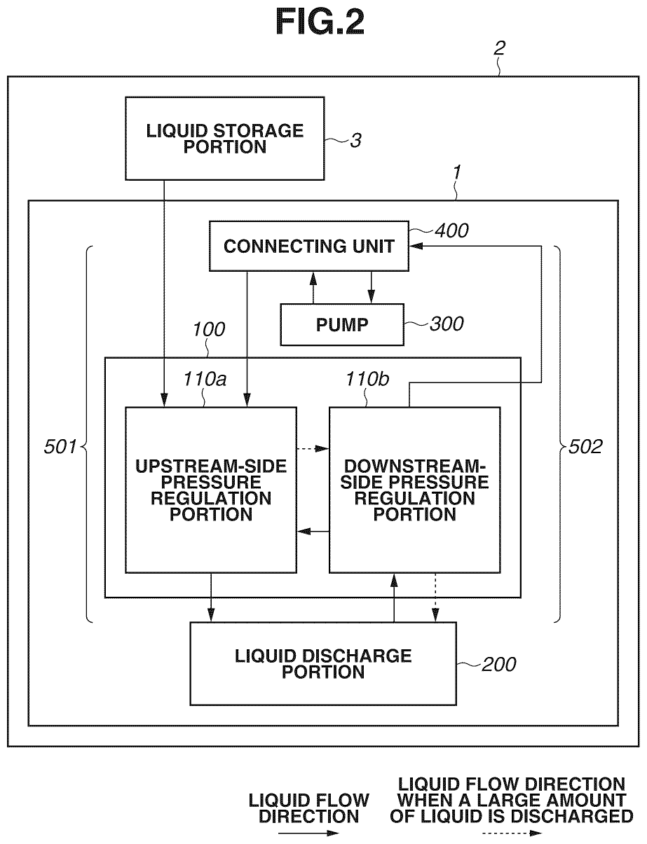

FIG. 2 is a schematic diagram illustrating a flow of liquid in a liquid discharge apparatus 2 including the liquid discharge head 1 according to the present exemplary embodiment. In a status in which a large amount of liquid is to be discharged, the liquid flows not only in directions indicated by a solid-line arrow in FIG. 2, but also in directions indicated by a dashed-line arrow.

The liquid discharge head 1 includes a liquid discharge portion 200 configured to discharge a liquid, a pressure regulation tank 100 (more than one pressure regulation tank 100 is illustrated in FIG. 1 but the description here is given of one of them) for regulating the pressure within the liquid discharge head 1 to a predetermined pressure, and a pump 300 (more than one pump 300 is illustrated in FIG. 1 but the description here is given of one of them) for circulating the liquid within the liquid discharge head 1. A flow path that connects the pump 300 and the pressure regulation tank 100 includes a connecting unit 400. The liquid discharge head 1 also includes an upstream-side flow path 501 for supplying a liquid to a discharge element substrate included in the liquid discharge portion 200, and a downstream-side flow path 502 for collecting a liquid from the discharge element substrate. In a configuration example illustrated in FIG. 2, the upstream-side flow path 501 is a flow path for supplying a liquid from the pump 300 to the liquid discharge portion 200, and the downstream-side flow path 502 is a flow path for collecting a liquid from the liquid discharge portion 200 into the pump 300. As described below, the pressure regulation tank 100 includes an upstream-side pressure regulation portion 110a that regulates the pressure of liquid within the upstream-side flow path 501, and a downstream-side pressure regulation portion 110b that regulates the pressure of liquid within the downstream-side flow path 502.

First, a liquid is supplied from a liquid storage portion 3 to the upstream-side pressure regulation portion 110a in the pressure regulation tank 100, and the pressure of the liquid is regulated to fall within a predetermined pressure range by the upstream-side pressure regulation portion 110a. After that, the liquid is supplied to the liquid discharge portion 200 and some of the liquid supplied to the liquid discharge portion 200 is discharged toward a recording medium or the like from the liquid discharge portion 200. The remaining liquid that has not been discharged from the liquid discharge portion 200 is collected into the downstream-side pressure regulation portion 110b in the pressure regulation tank 100, and the pressure of the liquid is regulated to fall within the predetermined pressure range. Then, the liquid flows from the downstream-side pressure regulation portion 110b to the pump 300 via the connecting unit 400, and is circulated again to the upstream-side pressure regulation portion 110a in the pressure regulation tank 100 via the connecting unit 400.

In the present exemplary embodiment, the liquid flowing out from the pump 300 flows back into the pressure regulation tank 100. Alternatively, the liquid may flow back into the liquid storage portion 3 instead of flowing back into the pressure regulation tank 100.

The liquid discharge head 1 according to the present exemplary embodiment is configured to discharge a plurality of colors of liquid. Accordingly, the liquid discharge head 1 includes a plurality of pressure regulation tanks 100 and a plurality of pumps 300 for the respective colors, and the pressure regulation tanks 100 and the pumps 300 are each connected to one liquid discharge portion 200 and one connecting unit 400.

Each component of the liquid discharge head 1 will be described.

The liquid discharge portion 200 includes the discharge element substrate (not illustrated) for discharging a liquid. The discharge element substrate is provided with a plurality of discharge ports (not illustrated) for discharging a liquid. The discharge element substrate is also provided with a pressure generation element (not illustrated) that generates a pressure for discharging a liquid, and the pressure generated by the pressure generation element acts on the liquid in a pressure chamber (not illustrated), so that the liquid is discharged from the discharge ports.

The pressure generation element according to the present exemplary embodiment may employ a thermal method of generating a pressure for discharging a liquid using a thermoelectric conversion element, or a piezoelectric method of generating a pressure for discharging a liquid using a piezoelectric element. Any type of pressure generation element may be used as long as the pressure generation element can generate a pressure.

While the present exemplary embodiment illustrates, as an example, a so-called serial type liquid discharge head that is mounted on a carriage that performs scanning on an object onto which a liquid is to be discharged from the liquid discharge head, the present exemplary embodiment is not limited to this example. The liquid discharge head according to the present exemplary embodiment may be a so-called full-line type liquid discharge head that includes discharge ports formed over an entire area in a width direction of an object onto which a liquid is to be discharged and is configured to discharge a liquid to the entire area in the width direction of the object onto which the liquid is to be discharged without involving any movement in a scanning direction.

The liquid supplied to the liquid discharge head 1 passes through the upstream-side flow path 501, which is connected to the discharge element substrate, and is supplied to the discharge element substrate. It is desirable that the upstream-side flow path 501 includes the upstream-side pressure regulation portion 110a for regulating the pressure of liquid within the upstream-side flow path 501. The upstream-side pressure regulation portion 110a will be described in detail below.

The liquid that has been supplied to the discharge element substrate and has not been discharged from the discharge element substrate passes through the downstream-side flow path 502, which is connected to the discharge element substrate, and is collected due to a change in the pressure generated by the pump 300. It is desirable that the downstream-side flow path 502 includes the downstream-side pressure regulation portion 110b for regulating the pressure of liquid within the downstream-side flow path 502. The downstream-side pressure regulation portion 110b will be described in detail below.

The pump 300 that is a characteristic portion of the present disclosure is connected to each of the upstream-side flow path 501 and the downstream-side flow path 502 and circulates the liquid within the liquid discharge head 1. In other words, the pump 300 is connected to each of the upstream-side flow path 501 and the downstream-side flow path 502 to cause the liquid within the downstream-side flow path 502 to flow out to the upstream-side flow path 501. The circulation of the liquid within the liquid discharge head 1 prevents thickening of ink and settling of a color material in the ink due to exposure of the ink to the external air through the discharge ports.

### (Pump)

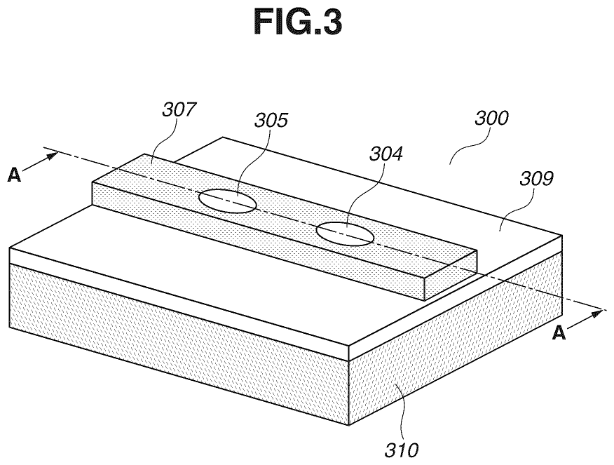

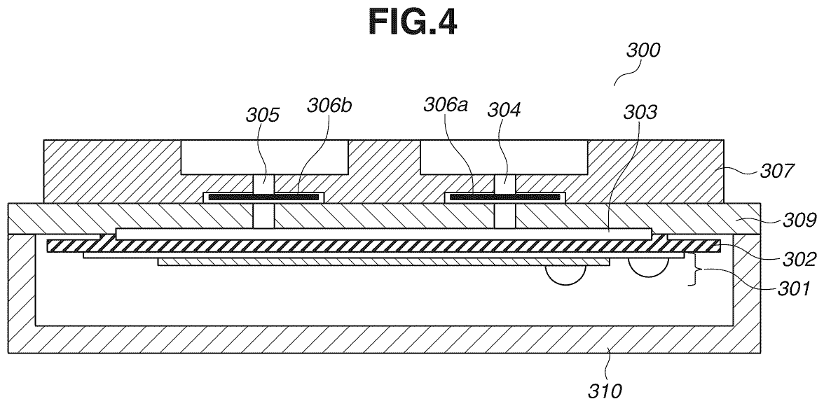

FIG. 3 is an external perspective view of the pump 300 according to the present exemplary embodiment. The pump 300 according to the present exemplary embodiment is a piezoelectric pump including a piezoelectric element 301 (FIG. 4) to be driven by application of a voltage and operating as an actuator. The piezoelectric pump can be implemented in a small size and thus can be desirably used as a pump to be mounted on the liquid discharge head 1. The pump 300 is not limited only to a piezoelectric pump, but instead may be any type of pump, such as a tube pump or a piston pump.

The pump 300 according to the present exemplary embodiment includes a support member 309 that supports a diaphragm 302 (FIG. 4) to be described below, a cover member 310 to be attached to the support member 309, and a joint plate 307 to be attached to the support member 309. The joint plate 307 is connected to each of the upstream-side flow path 501 and the downstream-side flow path 502. The joint plate 307 includes a pump inflow hole 304 that is connected to the downstream-side flow path 502 to cause the liquid within the downstream-side flow path 502 to flow into the pump 300. The joint plate 307 also includes a pump outflow hole 305 that is connected to the upstream-side flow path 501 to cause the liquid within the downstream-side flow path 502 to flow out to the upstream-side flow path 501.

FIG. 4 is a sectional view of the pump 300 taken along a line A-A illustrated in FIG. 3. The pump 300 includes the piezoelectric element 301 to be driven by application of a voltage, the diaphragm 302 to be deformed by driving of the piezoelectric element 301, and a pump chamber 303 that is surrounded by the diaphragm 302 and the support member 309. The pump inflow hole 304 is provided with a check valve 306a that can be opened only in the direction in which the liquid flows into the pump chamber 303. The pump outflow hole 305 is provided with a check valve 306b that can be opened only in the direction in which the liquid within the pump chamber 303 flows out. In other words, the liquid flowing into the pump chamber 303 from the pump inflow hole 304 flows out from the pump outflow hole 305, and the check valve 306a and the check valve 306b prevent the liquid from flowing in a reverse direction.

The piezoelectric element 301 is driven by application of a voltage from an electrode (not illustrated). When the piezoelectric element 301 is driven, the diaphragm 302 that is a flexible thin film disposed in contact with the piezoelectric element 301 is deformed. The pump chamber 303 is provided on a side of the diaphragm 302 that is not in contact with the piezoelectric element 301. When the piezoelectric element 301 is driven and the diaphragm 302 is deformed to be concave with respect to the pump chamber 303, the volume of the pump chamber 303 increases. In this case, the pressure within the pump chamber 303 decreases and the check valve 306a is opened in a state where the check valve 306b is closed, so that the liquid flows into the pump chamber 303 from the pump inflow hole 304. On the other hand, when the piezoelectric element 301 is driven and the diaphragm 302 is deformed to be convex with respect to the pump chamber 303, the volume of the pump chamber 303 decreases. In this case, the pressure within the pump chamber 303 increases and the check valve 306b is opened in a state where the check valve 306a is closed, so that the liquid within the pump chamber 303 flows out from the pump outflow hole 305. As a result of repeating this operation, the inflow of the liquid into the pump chamber 303 from the pump inflow hole 304 and the outflow of the liquid within the pump chamber 303 from the pump outflow hole 305 are repeated and the liquid within the downstream-side flow path 502 flows out to the upstream-side flow path 501.

As described above, the pump 300 sends a liquid using a change in the pressure within the pump chamber 303. However, if air bubbles are trapped in the pump chamber 303, a change in the pressure within the pump chamber 303 due to a change in the volume of the pump chamber 303 is used as a change in the volume of trapped air bubbles, which causes a pressure loss. In other words, the amount of liquid to be sent by the pump 300 decreases.

To address this issue, the pump 300 according to the present exemplary embodiment is characterized in that an opening of the pump outflow hole 305 faces upward in a substantially vertical direction in a use state of the liquid discharge head 1. A buoyant force acts on air bubbles generated in the liquid in a direction opposite to a gravitational direction (upward in the vertical direction). Also, in the use state of the liquid discharge head 1, the buoyant force acts on the air bubbles trapped in the pump chamber 303 upward in the vertical direction. In this case, the opening of the pump outflow hole 305 faces upward in the substantially vertical direction, and the pump outflow hole 305 is located at a destination to which the air bubbles within the pump chamber 303 are moved by the buoyant force, which facilitates discharge of the air bubbles from the pump outflow hole 305. In other words, the pressure loss in the pump 300 decreases and thus the pump 300 can effectively circulate the liquid.

The term “use state” of the liquid discharge head 1 as used herein refers to an orientation of the liquid discharge head 1 in a state where the liquid discharge head 1 is mounted on the liquid discharge apparatus and can discharge a liquid. Accordingly, in the use state of the liquid discharge head 1 according to the present exemplary embodiment, the liquid discharge head 1 may be configured to change in the orientation such that the opening of the pump outflow hole 305 faces upward in the substantially vertical direction.

The phrase “the opening of the pump outflow hole 305 faces upward in a substantially vertical direction” as used herein indicates that an angle formed between the vertical direction and a central axis passing through the center of the opening of the pump outflow hole 305 is less than or equal to 45 degrees. Further, the angle formed between the vertical direction and the central axis passing through the center of the opening of the pump outflow hole 305 is preferably less than or equal to 30 degrees. With this configuration, when a buoyant force acts on the liquid within the pump chamber 303, air bubbles can easily flow out from the pump outflow hole 305.

The pump chamber 303 is desirably located below the pump outflow hole 305 in the vertical direction. Further, the diaphragm 302 and the piezoelectric element 301 are desirably located in this order below the pump chamber 303 in the vertical direction. When the liquid within the pump chamber 303 flows out from the pump outflow hole 305 due to deformation of the diaphragm 302, the liquid flows from the lower side in the vertical direction to the upper side in the vertical direction. Accordingly, a thrust force acting on the liquid within the pump chamber 303 due to deformation of the diaphragm 302 acts in the direction in which the pump outflow hole 305 is located, which is the direction corresponding to an air bubble outflow direction. For this reason, air bubbles within the pump chamber 303 can easily flow out from the pump outflow hole 305.

Further, in the use state of the liquid discharge head 1, the opening of the pump inflow hole 304 desirably faces upward in the substantially vertical direction. The phrase “the opening of the pump inflow hole 304 faces upward in the substantially vertical direction” as used herein indicates that the angle formed between the vertical direction and the central axis passing through the center of the opening of the pump inflow hole 304 is less than or equal to 45 degrees. Further, the angle formed between the vertical direction and the central axis passing through the center of the opening of the pump inflow hole 304 is desirably less than or equal to 30 degrees. When a buoyant force acts on air bubbles contained in the liquid flowing from the downstream-side flow path 502 to the pump inflow hole 304, the configuration in which the opening of the pump inflow hole 304 is not located at a destination of the air bubbles makes it difficult for the air bubbles to flow into the pump chamber 303 from the pump inflow hole 304.

### (Connecting Unit)

The pump 300 is connected to the pressure regulation tank 100 via the connecting unit 400.

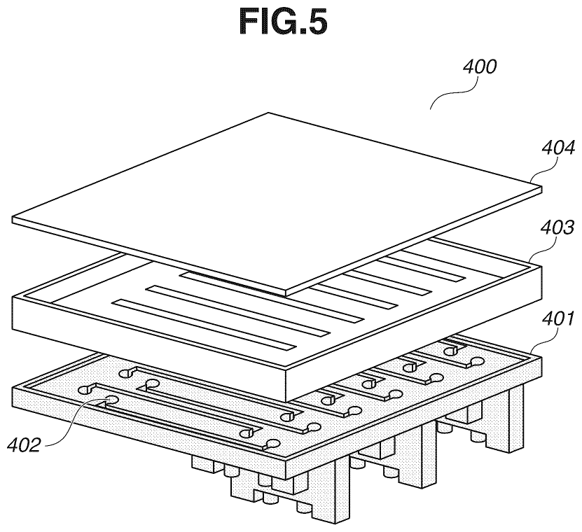

FIG. 5 is an exploded perspective view of the connecting unit 400. As illustrated in FIG. 1, the connecting unit 400 connects the plurality of pumps 300 and the plurality of pressure regulation tanks 100 to each other. The connecting unit 400 includes a flow path plate 401 that connects the upstream-side pressure regulation portions 110a of the plurality of pressure regulation tanks 100 and the pump inflow holes 304 of the plurality of pumps 300 to each other. Further, the flow path plate 401 connects the pump outflow holes 305 of the plurality of pumps 300 and the upstream-side pressure regulation portions 110a of the plurality of pressure regulation tanks 100 to each other. In addition, the flow path plate 401 includes a plurality of liquid flow paths 402 and the liquid flow paths 402 are configured such that liquid of different colors flow in the respective liquid flow paths 402. The flow path plate 401 is covered with a top cover 404 so as to cover the liquid flow paths 402 and a decompression portion 403.

Air bubbles flowing out from the pump outflow hole 305 of the pump 300 are trapped in the liquid flow paths 402 in the connecting unit 400. Accordingly, the connecting unit 400 desirably includes the decompression portion 403 that is connected to the outside of the liquid discharge head 1 and is brought into a reduced pressure state by an external decompression unit. Since air bubbles move from a location with a higher pressure to a location with a lower pressure, air bubbles within the liquid flow paths 402 are drawn into the decompression portion 403. If the decompression portion 403 is connected to the outside of the liquid discharge head 1, the air bubbles drawn into the decompression portion 403 can be discharged to the outside of the liquid discharge head 1.

The decompression portion 403 is desirably formed above the pump outflow hole 305 of the pump 300 in the vertical direction in the use state of the liquid discharge head 1. Not only the drawing force of the decompression portion 403, but also the buoyant force acts on the air bubbles flowing out from the pump outflow hole 305, which allows the air bubbles to be easily drawn into the decompression portion 403.

The connecting unit 400 is desirably fixed onto the joint plate 307 of the pump 300 with bolts (not illustrated). It is also desirable that a connecting portion between the pump 300 and the connecting unit 400 is hermetically sealed with a rubber ring (not illustrated).

### (Pressure Regulation Tank)

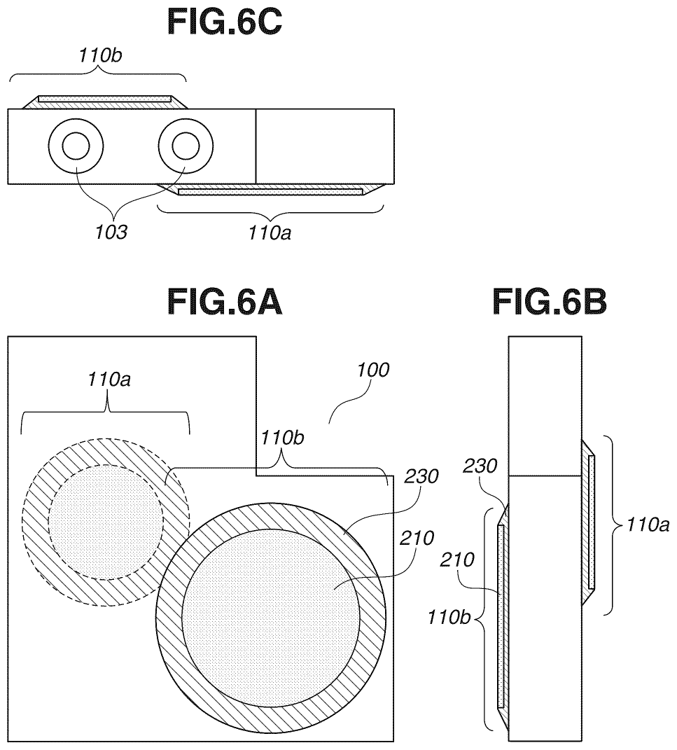

FIGS. 6A to 6C are schematic views of the pressure regulation tank 100 according to the present exemplary embodiment. FIG. 6A is a front view of the pressure regulation tank 100. FIG. 6B is a side view of the pressure regulation tank 100. FIG. 6C is a top view of the pressure regulation tank 100.

As illustrated in FIG. 2, the pressure regulation tank 100 is provided over the areas of the upstream-side pressure regulation portion 110a and the downstream-side pressure regulation portion 110b. The pressure regulation tank 100 includes the upstream-side pressure regulation portion 110a for regulating the pressure of liquid within the upstream-side flow path 501, and the downstream-side pressure regulation portion 110b for regulating the pressure of liquid within the downstream-side flow path 502.

A configuration example of each of the upstream-side pressure regulation portion 110a and the downstream-side pressure regulation portion 110b will be described. The upstream-side pressure regulation portion 110a and the downstream-side pressure regulation portion 110b have substantially the same configuration except that the pressure regulated by the downstream-side pressure regulation portion 110b is smaller than the pressure regulated by the upstream-side pressure regulation portion 110a. Therefore, the following description is given based on the upstream-side pressure regulation portion 110a.

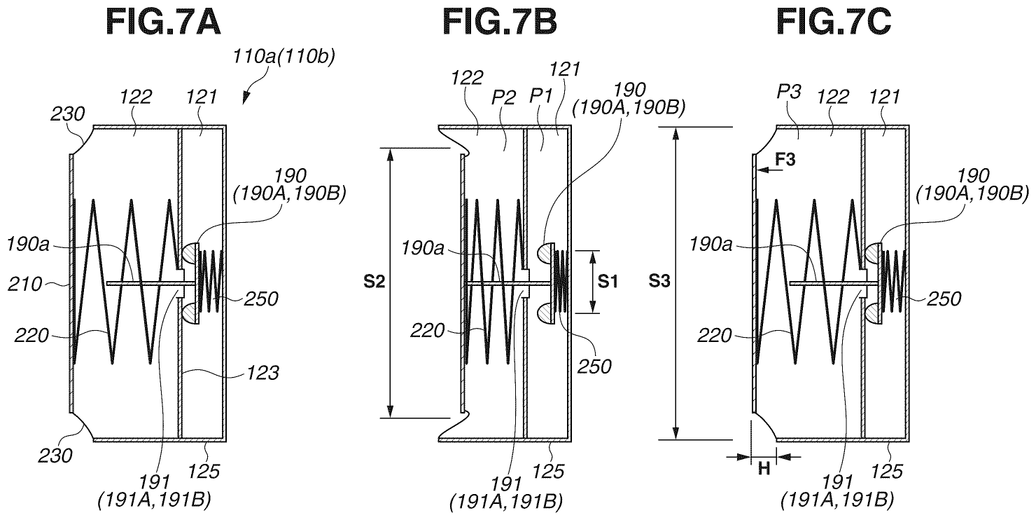

FIGS. 7A to 7C illustrate a configuration example of the upstream-side pressure regulation portion 110a. The upstream-side pressure regulation portion 110a includes a valve chamber 121 and a pressure regulation chamber 122 that are formed in a cylindrical housing 125. The valve chamber 121 and the pressure regulation chamber 122 are separated by a partition wall 123 that is provided in the cylindrical housing 125. In this case, however, the valve chamber 121 communicates with the pressure regulation chamber 122 via a communication port 191 that is formed in the partition wall 123. The valve chamber 121 is provided with a valve 190 to switch between communication and disconnection between the valve chamber 121 and the pressure regulation chamber 122 in the communication port 191. The valve 190 is held by a valve spring 200 at a position opposed to the communication port 191, and is configured to be brought into close contact with the partition wall 123 by a biasing force of the valve spring 200. When the valve 190 is brought into close contact with the partition wall 123, the flow of ink through the communication port 191 is interrupted. To enhance the close contact with the partition wall 123, a contact portion of the valve 190 that is in contact with the partition wall 123 is desirably formed of an elastic member. A valve shaft 190a to be inserted into the communication port 191 is provided at a central portion of the valve 190 in a protruding manner. The valve shaft 190a is pressed against the biasing force of the valve spring 200, thereby causing the valve 190 to be separated from the partition wall 123, so that ink can flow through the communication port 191. A state where the flow of ink through the communication port 191 is interrupted by the valve 190 is hereinafter referred to as a “closed state”, and a state where ink can flow through the communication port 191 is hereinafter referred to as an “open state”.

An opening portion of the cylindrical housing 125 is closed by a flexible member 230 and a pressure plate 210. The flexible member 230, the pressure plate 210, a peripheral wall of the housing 125, and the partition wall 123 form the pressure regulation chamber 122. The pressure plate 210 is configured to be displaced along with a displacement of the flexible member 230. The materials of the pressure plate 210 and the flexible member 230 are not particularly limited. For example, the pressure plate 210 may be formed of a resin molded part, and the flexible member 230 may be formed of a resin film. In this case, the pressure plate 210 can be fixed to the flexible member 230 by heat welding.

A pressure regulation spring 220 (elastic member) that is stretchable is provided between the pressure plate 210 and the partition wall 123. As illustrated in FIG. 7A, the pressure plate 210 and the flexible member 230 are biased by a biasing force of the pressure regulation spring 220 in the direction in which the internal volume of the pressure regulation chamber 122 increases. As the pressure within the pressure regulation chamber 122 decreases, the pressure plate 210 and the flexible member 230 are displaced in the direction in which the internal volume of the pressure regulation chamber 122 decreases against the pressure of the pressure regulation spring 220. When the internal volume of the pressure regulation chamber 122 decreases to a certain volume, the pressure plate 210 comes into contact with the valve shaft 190a of the valve 190. After that, when the internal volume of the pressure regulation chamber 122 further decreases, the valve 190 moves together with the valve shaft 190a against the biasing force of the valve spring 200, and is separated from the partition wall 123. This brings the communication port 191 into the open state (state illustrated in FIG. 7B).

In the present exemplary embodiment, the connection setting within a circulation path is made such that the pressure within the valve chamber 121 when the communication port 191 is in the open state becomes higher than the pressure within the pressure regulation chamber 122. Thus, when the communication port 191 is in the open state, ink flows into the pressure regulation chamber 122 from the valve chamber 121. The inflow of ink causes the flexible member 230 and the pressure plate 210 to be displaced in the direction in which the internal volume of the pressure regulation chamber 122 increases. As a result, the pressure plate 210 is separated from the valve shaft 190a of the valve 190, the valve 190 is brought into close contact with the partition wall 123 by the biasing force of the valve spring 200, and the communication port 191 is brought into the closed state (state illustrated in FIG. 7C).

As described above, in the upstream-side pressure regulation portion 110a according to the present exemplary embodiment, when the pressure within the pressure regulation chamber 122 decreases to a certain pressure or lower (e.g., negative pressure increases), ink flows from the valve chamber 121 via the communication port 191. This configuration prevents the pressure within the pressure regulation chamber 122 from being further decreased. Therefore, the pressure within the pressure regulation chamber 122 is regulated to be held within a certain pressure range.

Next, the pressure within the pressure regulation chamber 122 will be described in more detail.

Consider a state where the flexible member 230 and the pressure plate 210 are displaced depending on the pressure within the pressure regulation chamber 122 and the pressure plate 210 is brought into contact with the valve shaft 190a to bring the communication port 191 into the open state (state illustrated in FIG. 7B) as described above. In this case, a relation between forces acting on the pressure plate 210 is represented by the following equation (1).

$$P 2 \times S 2 + F 2 + ( P 1 - P 2 ) \times S 1 + F 1 = 0 \qquad Equation ( 1 )$$

If Equation (1) is rearranged in terms of P2, the following equation is obtained:

$$P 2 = - ( F 1 + F 2 + P 1 \times S 1 ) / ( S 2 - S 1 ) . \qquad Equation ( 2 )$$

P1: a pressure (gauge pressure) within the valve chamber 121
P2: a pressure (gauge pressure) within the pressure regulation chamber 122
F1: a spring force of the valve spring 200
F2: a spring force of the pressure regulation spring 220
S1: a pressure receiving area of the valve 190
S2: a pressure receiving area of the pressure plate 210

Assume herein that the direction in which the spring force F1 of the valve spring 200 and the spring force F2 of the pressure regulation spring 220 press the valve 190 and the pressure plate 210 is referred to as a positive direction (leftward in FIGS. 7A to 7C). The pressure P1 within the valve chamber 121 and the pressure P2 within the pressure regulation chamber 122 are set to satisfy a relation P1≥P2.

The pressure P2 within the pressure regulation chamber 122 when the communication port 191 is in the open state is determined by Equation (2). When the communication port 191 is in the open state and the relation P1≥P2 is satisfied, ink flows into the pressure regulation chamber 122 from the valve chamber 121. As a result, the pressure P2 within the pressure regulation chamber 122 does not further decrease and the pressure P2 is held within a certain pressure range.

On the other hand, the relation between forces acting on the pressure plate 210 when the pressure plate 210 is not in contact with the valve shaft 190a and the communication port 191 is in the closed state as illustrated in FIG. 7C is represented by the following equation (3).

$$P 3 \times S 3 + F 3 = 0 \qquad Equation ( 3 )$$

If Equation (3) is rearranged in terms of P3, the following equation (4) is obtained:

$$P 3 = - F 3 / S 3. \qquad Equation ( 4 )$$

F3: a spring force of the pressure regulation spring 220 when the pressure plate 210 and the valve shaft 190a are not in contact with each other
P3: a pressure (gauge pressure) within the pressure regulation chamber 122 when the pressure plate 210 and the valve shaft 190a are not in contact with each other
S3: a pressure receiving area of the pressure plate 210 when the pressure plate 210 and the valve 190 are not in contact with each other

FIG. 7C illustrates a state where the pressure plate 210 and the flexible member 230 are displaced leftward in FIG. 7C up to the limit of displacement. The pressure P3 within the pressure regulation chamber 122, the spring force F3 of the pressure regulation spring 220, and the pressure receiving area S3 of the pressure plate 210 vary depending on the amount of displacement while the pressure plate 210 and the flexible member 230 are displaced to the state illustrated in FIG. 7C. Specifically, when the pressure plate 210 and the flexible member 230 have moved rightward from the state illustrated in FIG. 7C, the pressure receiving area S3 of the pressure plate 210 decreases and the spring force F3 of the pressure regulation spring 220 increases. As a result, the pressure P3 within the pressure regulation chamber 122 decreases based on the relation represented by Equation (4). Accordingly, as in Equations (2) and (4), the pressure within the pressure regulation chamber 122 gradually increases (in other words, a negative pressure decreases to a value closer to a positive pressure) during transition from the state illustrated in FIG. 7B to the state illustrated in FIG. 7C. Specifically, the pressure plate 210 and the flexible member 230 are gradually displaced leftward from the state where the communication port 191 is in the open state, and the pressure within the pressure regulation chamber 122 gradually increases until the internal volume of the pressure regulation chamber 122 finally reaches the limit of displacement. In other words, the negative pressure decreases.

The upstream-side pressure regulation portion 110a and the downstream-side pressure regulation portion 110b have substantially the same configuration. Accordingly, the downstream-side pressure regulation portion 110b is also configured to perform pressure regulation as described above.

The pressure of liquid within the liquid discharge head 1 is set to be lower than the atmospheric pressure, so that air can enter the pressure regulation chamber 122 via the flexible member 230 from the atmosphere with time. The air having entered the pressure regulation chamber 122 may cause air bubbles in a liquid. The upstream-side pressure regulation portion 110a and the downstream-side pressure regulation portion 110b are configured to perform pressure regulation using deformation of the flexible member 230. Accordingly, if air bubbles in the liquid are trapped in the upstream-side pressure regulation portion 110a and the downstream-side pressure regulation portion 110b and the flexible film is expanded, it is difficult to normally perform pressure regulation. Since a buoyant force acts on air bubbles in the liquid upward in the vertical direction, the pressure regulation spring 220 is desirably provided to be stretchable in the substantially horizontal direction in the use state of the liquid discharge head 1 so that air bubbles within the pressure regulation chamber 122 can be easily discharged using the buoyant force. The term “substantially horizontal direction” indicates that the angle formed between the vertical direction and the direction in which the pressure regulation spring 220 stretches is more than or equal to 45 degrees.

Further, in the use state of the liquid discharge head 1, connecting ports 103 at an upper end of the upstream-side pressure regulation portion 110a are desirably connected to the connecting unit 400 including the decompression portion 403. With this configuration, when the buoyant force acts on air bubbles within the upstream-side pressure regulation portion 110a, the air bubbles can be discharged from the upstream-side pressure regulation portion 110a and can be easily drawn into the decompression portion 403 of the connecting unit 400.

Similarly, in the use state of the liquid discharge head 1, the connecting portions 103 at the upper end of the downstream-side pressure regulation portion 110b are desirably connected to the connecting unit 400 that is located above the downstream-side pressure regulation portion 110b and includes the decompression portion 403. With this configuration, when the buoyant force acts on air bubbles within the downstream-side pressure regulation portion 110b, the air bubbles can be easily guided to the connecting unit 400. Further, the air bubbles are eliminated by the decompression portion 403 of the connecting unit 400, thereby reducing the possibility that air bubbles enter the pump 300 from the pump inflow hole 304.

The pressure regulation tank 100 and the connecting unit 400 are desirably fixed with bolts (not illustrated). Further, it is desirable that the connecting portion between the pressure regulation tank 100 and the connecting unit 400 is hermetically sealed with a rubber ring (not illustrated).

### (Layout of Pumps and Pressure Regulation Tanks)

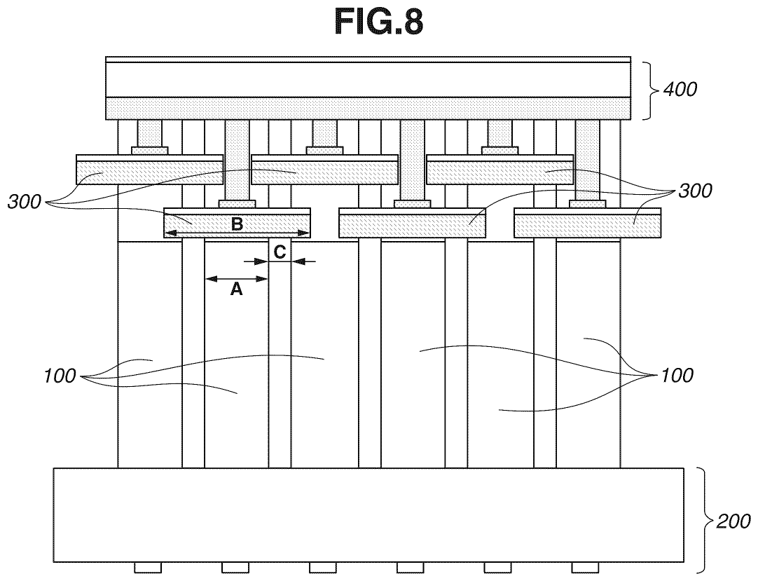

FIG. 8 is an external front view of the liquid discharge head 1 including the plurality of pumps 300 and the plurality of pressure regulation tanks 100. As described above, the pump 300 is configured such that the opening of the pump outflow hole 305 faces upward in the substantially vertical direction in the use state of the liquid discharge head 1 so that air bubbles trapped in the pump chamber 303 can easily flow out from the outflow hole 305. As described above, to easily discharge air bubbles trapped in the pump chamber 303, the pressure regulation spring 220 included in each of the upstream-side pressure regulation portion 110a and the downstream-side pressure regulation portion 110b in the pressure regulation tank 100 is desirably configured to be stretchable in the substantially horizontal direction.

When the pumps 300 and the pressure regulation tanks 100 are arranged to satisfy the above-described layout, the width (“B” in FIG. 8) in the horizontal direction of each pump 300 may be greater than the width (“A” in FIG. 8) in the horizontal direction of each pressure regulation tank 100. In this case, if the interval (“C” in FIG. 8) between the pressure regulation tanks 100 adjacent to each other in the horizontal direction is set to be greater than the width (“B” in FIG. 8) in the horizontal direction of the pump 300, the liquid discharge head 1 is increased in size and cost.

As illustrated in FIG. 8, the liquid discharge head 1 according to the present exemplary embodiment has a configuration in which the upper ends of the plurality of adjacent pumps 300 adjacent to each other are located at different positions in the vertical direction in the use state of the liquid discharge head 1. With this configuration, the interval (“C” in FIG. 8) between the pressure regulation tanks 100 adjacent to each other in the horizontal direction can be set to be smaller than the width (“B” in FIG. 8) in the horizontal direction of each pump 300, thereby making it possible to reduce the size and cost of the liquid discharge head 1.

As described above, the liquid discharge head 1 according to the present exemplary embodiment has a configuration in which the opening of the pump outflow hole 305 faces upward in the substantially vertical direction in the use state of the liquid discharge head 1, which facilitates discharge of air bubbles trapped in each pump 300.

The present disclosure is characterized in that the liquid discharge head 1 includes the pumps 300. The configuration in which the liquid discharge head 1 includes the pumps 300 makes it possible to reduce the length of the flow path in which a liquid is circulated as compared with a case where the main body of the liquid discharge apparatus 2 is provided with the pumps 300. With this configuration, the total amount of ink present in the flow path in which ink is circulated is reduced, which leads to a reduction in the amount of air bubbles trapped in the pump chamber 303. Further, if the flow path is formed of a flexible tube, the length of the flow path formed of the tube is short, which leads to a reduction in the amount of atmospheric air entering the flowing path from the tube. In addition, as the circulation flow path increases in length, the flow resistance of liquid increases, so that a high circulation capability is preferable for the pump 300. In other words, it may be preferable to increase the size of the pump 300, which leads to an increase in the cost of the liquid discharge head 1. In view of the above, it is desirable that the liquid discharge head 1 according to the present exemplary embodiment includes the pumps 300.

A configuration example of a liquid discharge head 1 according to a second exemplary embodiment of the present disclosure will be described. In the following description, only differences between the second exemplary embodiment and the first exemplary embodiment will be mainly described, and descriptions of components similar to those of the first exemplary embodiment will be omitted.

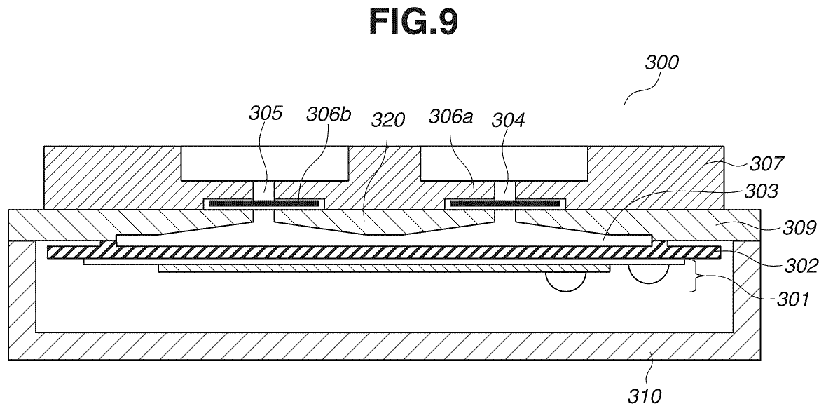

FIG. 9 is a sectional view of the pump 300 included in the liquid discharge head 1 according to the second exemplary embodiment. The pump chamber 303 of the pump 300 according to the second exemplary embodiment is characterized by including an inclined surface 320 that is inclined such that the width of the pump chamber 303 gradually decreases toward the pump outflow hole 305. When air bubbles within the pump chamber 303 come onto contact with the inclined surface 320 due to a buoyant force, the air bubbles are guided into the pump outflow hole 305 along the inclined surface 320, so that the air bubbles can easily flow out from the pump outflow hole 305.

As described above, the liquid discharge head 1 according to the second exemplary embodiment is configured such that the opening of the pump outflow hole 305 faces upward in the vertical direction in the use state of the liquid discharge head 1, thereby facilitating discharge of air bubbles trapped in the pump chamber 303. Further, the pump chamber 303 includes the inclined surface 320 that is inclined such that the width of the pump chamber 303 gradually decreases toward the pump outflow hole 305, thereby facilitating discharge of air bubbles within the pump chamber 303.

### Other Exemplary Embodiments

The disclosure of the exemplary embodiments includes an example of a liquid discharge head and a configuration typified by a liquid discharge apparatus as described below.

Any combination of configurations according to the exemplary embodiments described above is also applicable.

According to an aspect of the present disclosure, it is possible to provide a liquid discharge head including a pump that facilitates discharge of air bubbles trapped in the pump, and a liquid discharge apparatus including the liquid discharge head.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-173397, filed Oct. 5, 2023, which is hereby incorporated by reference herein in its entirety.

What is claimed is:

1. A liquid discharge head comprising:
a discharge element substrate configured to discharge a liquid;
an upstream-side flow path connected to the discharge element substrate and configured to supply a liquid to the discharge element substrate;
a downstream-side flow path connected to the discharge element substrate and configured to collect a liquid from the discharge element substrate; and
a pump connected to each of the upstream-side flow path and the downstream-side flow path and configured to cause a liquid within the downstream-side flow path to flow out to the upstream-side flow path,
wherein the pump includes a pump outflow hole for causing the liquid within the downstream-side flow path to flow out to the upstream-side flow path, and
wherein, in a use state of the liquid discharge head, an opening of the pump outflow hole faces upward in a substantially vertical direction.

2. The liquid discharge head according to claim 1, wherein an angle formed between a vertical direction and a central axis passing through a center of the opening of the pump outflow hole is less than or equal to 45 degrees.

3. The liquid discharge head according to claim 1, wherein an angle formed between a vertical direction and a central axis passing through a center of the opening of the pump outflow hole is less than or equal to 30 degrees.

4. The liquid discharge head according to claim 1,
wherein the pump further includes a pump inflow hole for causing the liquid within the downstream-side flow path to flow into the pump, and
wherein, in the use state of the liquid discharge head, an opening of the pump inflow hole faces upward in the substantially vertical direction.

5. The liquid discharge head according to claim 4, wherein an angle formed between a vertical direction and a central axis passing through a center of the opening of the pump inflow hole is less than or equal to 45 degrees.

6. The liquid discharge head according to claim 4, wherein an angle formed between a vertical direction and a central axis passing through a center of the opening of the pump inflow hole is less than or equal to 30 degrees.

7. The liquid discharge head according to claim 1, wherein the pump further includes:
a piezoelectric element configured to be driven by application of a voltage;
a diaphragm configured to be deformed by driving of the piezoelectric element;
a support member configured to support the diaphragm; and
a pump chamber surrounded by the diaphragm and the support member.

8. The liquid discharge head according to claim 7, wherein the pump chamber includes an inclined surface to be inclined such that a width of the pump chamber gradually decreases toward the pump outflow hole.

9. The liquid discharge head according to claim 1, wherein the upstream-side flow path is provided with a decompression portion within which a pressure is reduced by an external decompression unit.

10. The liquid discharge head according to claim 9, wherein, in the use state of the liquid discharge head, the decompression portion is provided above the pump outflow hole in a vertical direction.

11. The liquid discharge head according to claim 1, wherein the upstream-side flow path is provided with an upstream-side pressure regulation portion configured to regulate a pressure of liquid within the upstream-side flow path.

12. The liquid discharge head according to claim 11,
wherein the upstream-side pressure regulation portion includes an elastic member configured to be stretched by a pressure within the upstream-side pressure regulation portion, and
wherein, in the use state of the liquid discharge head, the elastic member is stretched in a substantially horizontal direction.

13. The liquid discharge head according to claim 11,
wherein, in the upstream-side flow path, a flow path between the pump and the upstream-side pressure regulation portion is provided with a decompression portion within which a pressure is reduced by an external decompression unit, and
wherein, in the use state of the liquid discharge head, an upper end of the upstream-side pressure regulation portion is connected to the flow path provided with the decompression portion.

14. The liquid discharge head according to claim 1, wherein the downstream-side flow path is provided with a downstream-side pressure regulation portion configured to regulate a pressure of liquid within the downstream-side flow path.

15. The liquid discharge head according to claim 14,
wherein the downstream-side pressure regulation portion is provided with an elastic member configured to be stretched by a pressure within the downstream-side pressure regulation portion, and
wherein, in the use state of the liquid discharge head, the elastic member is stretched in a substantially horizontal direction.

16. The liquid discharge head according to claim 1, further comprising a plurality of the pumps,
wherein, in the use state of the liquid discharge head, upper ends of the plurality of pumps adjacent to each other are located at different positions in a vertical direction.

17. A liquid discharge apparatus comprising:
a liquid discharge head including:
a discharge element substrate configured to discharge a liquid;
an upstream-side flow path connected to the discharge element substrate and configured to supply a liquid to the discharge element substrate;
a downstream-side flow path connected to the discharge element substrate and configured to collect a liquid from the discharge element substrate; and
a pump connected to each of the upstream-side flow path and the downstream-side flow path and configured to cause a liquid within the downstream-side flow path to flow out to the upstream-side flow path, the pump including a pump outflow hole for causing the liquid within the downstream-side flow path to flow out to the upstream-side flow path, an opening of the pump outflow hole facing upward in a substantially vertical direction in a use state of the liquid discharge head; and
a carriage on which the liquid discharge head is mounted, the carriage being configured to perform scanning on an object onto which a liquid is to be discharged from the liquid discharge head.
